(19) United States
(12) Patent Application Publication
(10) Pub. No.: US 2008/0271127 A1
(43) Pub. Date: Oct. 30, 2008

(54) APPARATUS AND METHOD FOR CREATING STAND-ALONE BUSINESS INTELLIGENCE WIDGETS WITHIN AN AUTHENTICATION FRAMEWORK

(75) Inventors: Alexis-Jean Laurent NAIBO, Levallois Perret (FR); Didier Marc Jean BOLF, Boulogne-Billancourt (FR)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/739,636

(22) Filed: Apr. 24, 2007

(51) Int. Cl. H04L 9/32; G06F 17/00

(52) U.S. Cl. 726/6; 705/1; 707/E17.005

(57) ABSTRACT

A computer readable storage medium includes executable instructions to retrieve a list of one or more widgets from a repository. A set of items representing the list of one or more widgets is displayed. A widget is selected from amongst the one or more widgets in the repository. The widget is configured with a set of authentication credentials

### BRIEF DESCRIPTION OF THE INVENTION

This invention relates generally to data storage and retrieval for the purposes of reporting. More particularly, this invention relates to techniques for embedding authentication into widgets for creating presentations of business intelligence data in a plurality of environments.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information, content delivery infrastructure systems for delivery and management of reports and analytics, data warehousing systems for cleansing and consolidating information from disparate sources. Business Intelligence tools work with data management systems, such as relational databases or On Line Analytic Processing (OLAP) systems used to collect, store, and manage raw data.

A subset of business intelligence tools are reporting tools. There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike, other non-report documents that may optionally import external data within a document, a report document by design is primarily a medium for accessing and, formatting, transforming and or presenting external data.

A report is specifically designed to facilitate working with external data sources. In addition to information regarding external data source connection drivers, the report may specify advanced filtering of data, information for combining data from different external data sources, information for updating join structures and relationships in report data, and instructions including logic to support a more complex internal data model (that may include additional constraints, relationships, and metadata).

In contrast to a spreadsheet type application, a report generation tool is generally not limited to a table structure but can support a range of structures, such as sections, cross-tables, synchronized tables, sub-reports, hybrid charts, and the like. A report design tool is designed primarily to support imported external data, whereas a spreadsheet application equally facilitates manually entered data and imported data. In both cases, a spreadsheet application applies a spatial logic that is based on the table cell layout within the spreadsheet in order to interpret data and perform calculations on the data. In contrast, a report design tool is not limited to logic that is based on the display of the data, but rather can interpret the data and perform calculations based on the original (or a redefined) data structure and meaning of the imported data, the report may also interpret the data and perform calculations based on pre-existing relationships between elements of imported data. Spreadsheets applications generally work within a looping calculation model, whereas a report generation tools may support a range of calculation models. Although there may be an overlap in the function of a spreadsheet document and a report document, the applications used to generate these documents contain instructions with express different assumptions concerning the existence of an external data source and different logical approaches to interpreting and manipulating imported data.

Known reporting tools are often limited to the environment in which business intelligence data is available to the user For example, a report can be consumed in a report designer, a report viewer, as a printed or exported document and the like. Often the consumers of business intelligence data use a variety of other tools in combination with, and at the same time as, their business intelligence tools. Therefore, the user in using other tools may be separated from the business intelligence data they need. Some apparatus and methods have been proposed to address this, such as, business intelligence on a mobile device or in a report aggregator such as a dashboard. However, it would be desirable to create a business intelligence tool that would allow a user to consume business intelligence data in their normal work environment. It is desirable to have the business intelligence both ambient to and accessible from the user's normal environment.

A widget is a small web based client application. Widgets are specialized web content readers or creators distinct from web browsers—general web content readers. Widgets usually have a compact user interface to allow them to be always open, running and sitting on the desktop in the Graphical User Interface (GUI) of an Operating System (OS). Widgets make the desktop more amenable to multi-tasking. Widgets are also called gadgets and panels. Typical applications for a widget include consuming local or remote data. For example, widgets can act as a viewer for local pictures, a reader for data feeds, an alert panel and the like. Widgets can accept input, e.g., a preconfigured search widget. This input can be uploaded to the web. A widget is to be contrasted with an applet such as a calendar, clock or calculator which does not consume data.

A widget can consume, aggregate, perform calculations on, and display data. T his data can be cached. A widget can have persistent data in addition to the cached data and data to facilitate communication. A role of this persistent data is to augment, replace, or parameterize calculations on the data retrieved locally or across a network—e.g., from a BI server or the web. A widget can have persistent configuration data to set the look and function of the widget. The function of a widget includes the rate at which that data is refreshed and how the widget accesses its data. Persistent data can have a role in security. A widget and its server side counterpart, the data provider, can have a security model directed towards the intended function(s) of the widget. For example, a widget can be an interface to a data feed requiring subscription.

Widgets operate in conjunction with a widget engine. The engine uses a programming, scripting, and or markup language (e.g., XML) interpreter to provide the framework for the widgets to run. Widgets are easy to create and popular in that they are typically created with a few lines to a few hundred lines of code in a programming, scripting, or markup language.

### SUMMARY OF INVENTION

The invention includes a computer readable storage medium with executable instructions to retrieve a list of one or more widgets from a repository. A set of items representing the list of one or more widgets is displayed. A widget is selected from amongst the one or more widgets in the repository. The widget is configured with a set of authentication credentials

The invention also includes a computer readable storage medium with executable instructions to define a repository at a business intelligence server. The repository stores business intelligence documents. A repository explorer interfaces with the repository. The repository explorer accesses a set of business intelligence documents in the repository. A widget instance is created. The widget instance is based on a business intelligence document from the set of business intelligence documents in the repository and a set of information. The set of information personalizes the operation of the widget.

### BRIEF DESCRIPTION OF THE FIGURES

The invention is more fully appreciated in connection with the following detailed description taken in conjunction with the accompanying drawings, in which:

FIG. 1 illustrates a computer constructed in accordance with an embodiment of the invention.

FIG. 2 illustrates a system including a business intelligence server and two consumers in accordance with an embodiment of the invention.

FIG. 3 illustrates processing operations associated with invoking a business intelligence document repository explorer in accordance with an embodiment of the invention.

FIG. 4 illustrates processing operations associated with initializing a widget and transferring it from a business intelligence document repository explorer to a new environment in accordance with an embodiment of the invention.

FIG. 5 illustrates processing operations associated with creating a widget from a report part and transferring the widget to a new environment in accordance with an embodiment of the invention.

FIG. 6 illustrates a graphical user interface (GUI) including a repository explorer connected to one repository in accordance with an embodiment of the invention.

FIG. 7 illustrates a portion of a workflow for adding another repository connection to the repository explorer of FIG. 6.

FIG. 8 illustrates the repository explorer of FIG. 6 connected to two repositories.

FIG. 9 illustrates the repository explorer of FIG. 6 including a detailed view of items in the two connected repositories.

FIGS. 10, 11 and 12 illustrate a series of widgets placed on the desktop of the GUI of an operating system in accordance with an embodiment of the invention.

FIG. 13 illustrates the creation of a widget from a report part in accordance with an embodiment of the invention.

Like reference numerals refer to corresponding parts throughout the several views of the drawings.

### DETAILED DESCRIPTION OF THE INVENTION

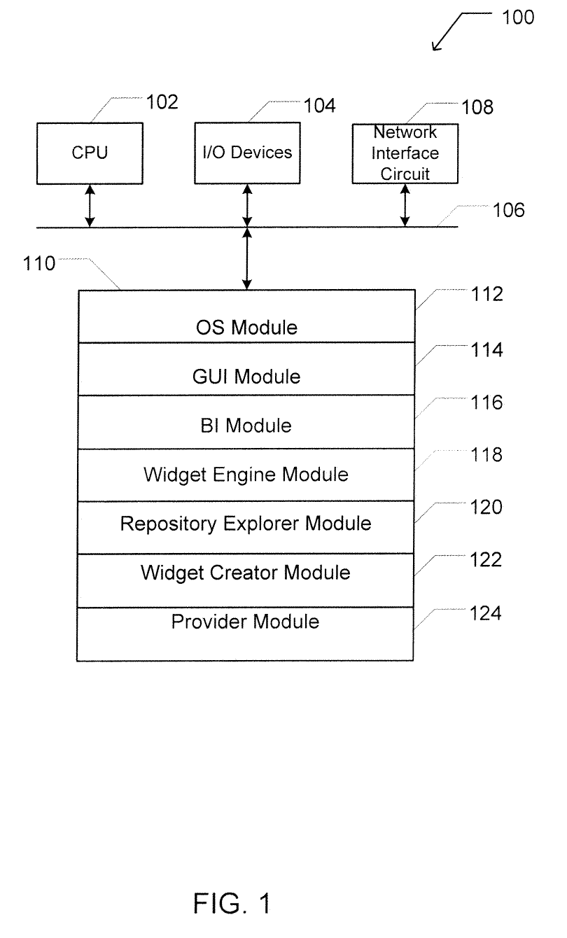

FIG. 1 illustrates a computer 100 configured in accordance with an embodiment of the invention. The computer 100 includes standard components, including a central processing unit 102 and input output devices 104, which are linked by a bus 106. The input/output devices 104 may include a keyboard, mouse, touch screen, monitor, printer, and the like. A network interface circuit 108 is also connected to the bus 106. The network interface circuit (NIC) 108 provides connectivity to a network (not shown), thereby allowing the computer 100 to operate in a networked environment.

A memory 110 is also connected to the bus 106. In an embodiment, the memory 110 stores one or more of the following modules: an operating system (OS) module 112, a graphical user interface (GUI) module 114, a business intelligence (BI) module 116, a widget engine module 118, a repository explorer module 120, a widget creator module 122, and a provider module 124. In an embodiment, computer 100 operates as a client and includes the widget engine module 118, the repository explorer module 120 and the widget creator module 122. In another embodiment, computer 100 operates as a server and includes the BI module 116 and the provider module 122.

The operating system module 112 may include instructions for handling various system services, such as file services or for performing hardware dependant tasks. The GUI module 114 may rely upon standard techniques to produce graphical components of a user interface, e.g., windows, icons, buttons, menus and the like, examples of which are discussed below.

The BI module 116 includes executable instructions to perform BI related functions on computer 100 or across a wider network. BI related functions include generating reports, performing queries and analyses, and the like. The BI module 116 includes instructions to implement authentication. Authentication is the act of establishing that something or someone is authentic. In computer security, authentication is the process of attempting to verify the digital identity of the sender of a communication, such as, a request to login in. The sender being authenticated may be a person using a computer, a computer, itself or a program. Authentication can be implemented by instructions in the BI module 116. The authentication can occur at the BI server level. In some embodiments, the authentication occurs at the application, widget, data, repository, or repository explorer level. The BI module 116 can be used to access a data source or a business intelligence document repository (both not shown).

The widget engine module 118 defines a widget engine. The widget engine is a framework to execute one or more widgets. The widget engine module 118 may be implemented as a prior art widget engine. The module 118 includes instructions that interpret the definition of a widget and in conjunction with instruction in the GUI module 114 display the widget in the user interface of a computer. The widget engine module 118 includes executable instructions to aid a widget in the consumption of data from a data provider. The widget engine module 118 may include executable instructions to create a widget framework that supports one or more widgets with a common element. For example, a framework could be for a set of widgets with a shared data source, a shared user, and the like. In an embodiment, the role of a widget engine is fulfilled by a service provided by the operating system module 112 of computer 100.

The repository explorer module 120 includes executable instructions to support access to one or more widget repositories at a BI client. The BI client is provided by executions in the BI module 116. The executable instructions include instructions to add more repositories to the view defined by the access. The module can include further instructions to search the BI documents (e.g., widgets and reports) in the one or more repositories or filter BI documents in the view. In an embodiment, the module 120 includes instruction to allow a user to navigate the plurality of BI documents as a hierarchy, for example, by folder and file, category time of last use, data source, and the like.

The widget creator module 122 may include instructions to allow a user to define widgets: parameterize a widget, link two widgets together, program a widget, create a widget from a report part, and the like. The executable instructions to create a widget from a report part may be implemented in accordance with any number of techniques, including those described in the following pending, commonly owned patent application, which is incorporated by reference herein in its entirety “Apparatus and Method for Defining Report Parts”, application Ser. No. 11/558,861, filed Nov. 9, 2006.

The provider module 124 includes executable instructions to provide data to a consumer—i.e., a widget. The data can be provided from a BI server or a data source. This data can be structured and include metadata. Examples of suitable data formats include Really Simple Syndication (RSS) feeds, eXtensible Markup Language (XML) added to data to state its structure or add other metadata, a Web Service (WS) and the like. The module 124 includes executable instructions to receive a request for data from, and provide data to, a widget. In an embodiment, the provider module 124 includes executable instructions to configure a WS provider to run on a public internet protocol IP address and optionally set up security controls on access.

The executable modules stored in memory 110 are exemplary. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

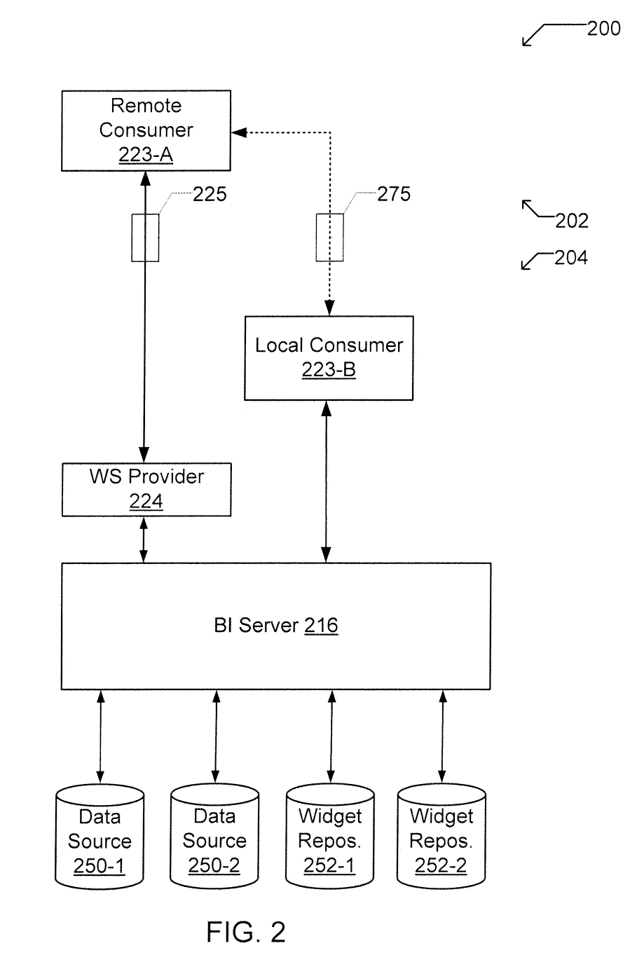

FIG. 2 illustrates the interrelationship and interactions between software components defined by the instructions stored in computer 100. These components and their interactions define a widget client-server system 200 in accordance with an embodiment of the invention. The system 200 includes a remote region 202 and local region 204. The remote region 202 includes a remote consumer 223-A. The local region 204 includes a local consumer 223-B. The consumers 223-A and 223-B are each a user interface, or separate system. The consumers 223-A and 223-B can each execute one or more widget instances. In an embodiment, each consumer can support one or more widget frameworks. Each framework can have one or more widget instances. These widget instances are supported and displayed to the user at each consumer via the instructions stored in the GUI module 114 and widget engine module 118.

The local region 204 includes a BI server 216, a WS provider 224 and one or more data sources and metadata repositories. The BI server 216 is defined by executable instructions in the BI module 116. The WS provider 224 is defined by executable instructions in the provider module 124. The BI server 216 is coupled to the WS provider 224. The WS provider 224 is coupled to the remote consumer 223-A via a communication channel 225—any wired or wireless channel. The local consumer 223-B is connected to the BI server 216. Also coupled to the BI server 216 are one or more data sources (e.g. 250-1, 250-2) and widget repositories (e.g., 252-1, 252-2). The widget repositories include listings of various business intelligence documents, such as, reports and widgets. Each consumer (i.e., 223-A and 223-B) can have a customized access to content of one or more repositories.

A consumer requests data for a widget from the WS provider 224. The provider 224 in conjunction with the BI server 216 and a data source 250 supplies the data to the widget. In an embodiment, the BI server is not present and the WS provider works with the data source 250 directly. In another embodiment, the local consumer 223-B communicates with the BI server through the WS provider 224. The local consumer 223-B may be coupled to a remote consumer 223-A via communication channel 275—any wired or wireless channel. This channel can be used by the user at a consumer to send (e.g., email) a widget to another user at the other consumer.

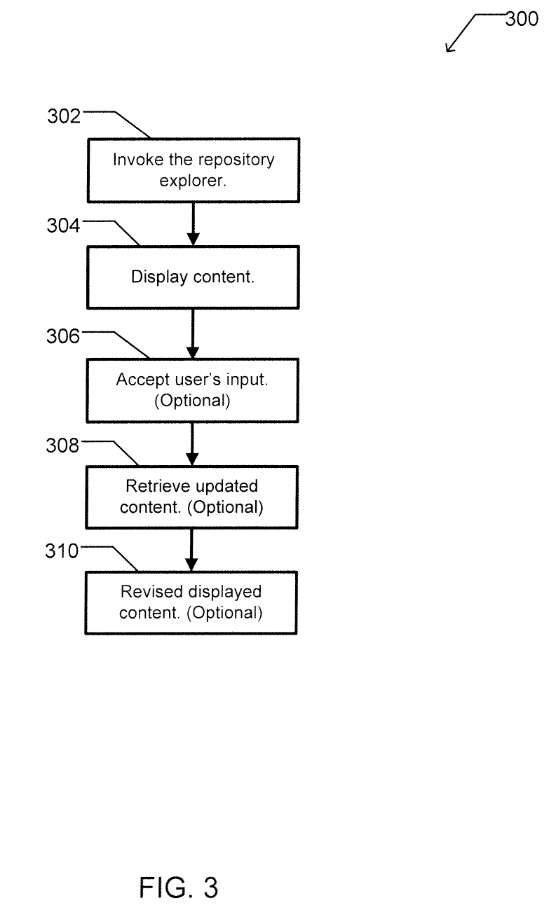

FIG. 3 illustrates a set processing operations 300 performed by a consumer associated with invoking a business intelligence document repository explorer. The consumer initializes a repository explorer 302. This includes requesting content from any business intelligence document repositories the explorer is configured to access, such as, default or previously configured repositories. Using supplied credentials and identified repositories, the repository explorer displays the items in each repository 304. In an embodiment, the content displayed is subject to the authentication credentials of the user. In an embodiment, security is implemented at the explorer and repository level.

The set of processing operations 300 has many optional operations. Optionally, the explorer accepts user's input of additional information 306. This additional information includes search criteria, filter criteria, authentication credentials or a new data source. Optionally, the explorer retrieves updated items 308. That is the explorer, searches the existing repositories, updates the items in the view based on the access level of new credentials supplied, or accesses a new data source. Optionally, the explorer may update the displayed items 310. That is the explorer, changes how items are displayed. For example, the explorer applies a filter to the business intelligence documents currently displayed in the view or reconfigures the view to show the items in a new way, such as, (reverse) alphabetically, (reverse) numerically, a new display hierarchy based on data known to the explorer such as folder and file category time of last use underlying data source, and the like.

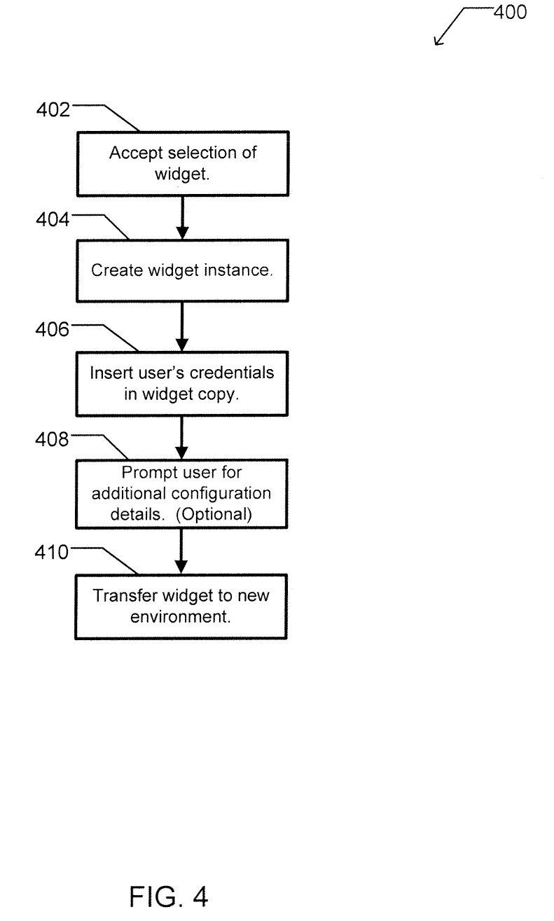

FIG. 4 illustrates processing operations 400 associated with creating a widget instance and transferring it from a business intelligence document repository explorer to a new environment. The set of processing operations are performed at the repository explorer and or the BI server. A widget instance is made from a widget template or another widget instance. The widget instance is a template with authentication and configuration information added. A widget template is a widget instance with a placeholder for authentication and configuration information. The authentication and configuration information can be specified in XML or a proprietary format. Authentication information includes credentials. Configuration information relates to the look and function of a widget. The repository explorer accepts the selection of a widget 402. The selection of a widget may include dragging a widget from the repository explorer to a new environment. The widget is a widget template or a widget instance. In an embodiment, the BI server creates a widget instance 404. In an alternative embodiment, the repository explorer creates the instance of the widget.

Credentials are inserted into the widget instance 406. Credentials allow the widget to access its data source. In an embodiment, the credentials are user credentials that allow the widget to access the data source on behalf of the user. The credentials may be for a user group, role, system, network, time period and the like. The credentials can include a token, potentially time limited, that allows one user to send another user a widget. In an embodiment, the credentials are stored within the widgets framework. The insertion of credentials into the widget instance creates a personalized widget that is ready for use. This widget instance, after operation 406, has been personalized without the need for programming the widget to act in a personalized way.

Optionally, the user is prompted to set up any further configuration information 408. These configuration details may include, automated refresh period, behavior around stored data, preferences, sharing or copying settings, black listed users, appearance, and the like. The widget is transferred to its new environment 410. This transfer can be the completion of the repository explorer's response to a drag-and-drop action. The new operation environment is one where the widget can run—i.e., access the services of a widget engine. Another suitable new environment may include the desktop of an operating system. Another new environment is an email application. Other possible environments include a word processing document, a web content document, a publishing document and the like.

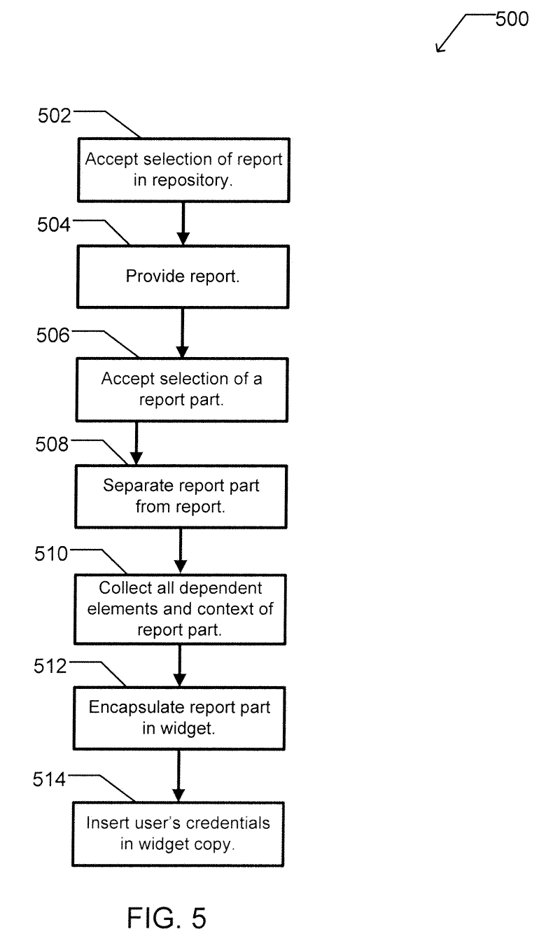

FIG. 5 illustrates processing operations associated with creating a widget from a report part and transferring the widget to a new environment in accordance with an embodiment of the invention. The repository explorer accepts the selection of a report 502. In an embodiment, the report is stored in the widget repository the repository explorer is connected to. In an embodiment, a representation of a business intelligence document (e.g., reports and widgets) is stored in the repository and the business intelligence document is stored elsewhere. As this abstraction is transparent to the user, without loss of generality, the term stored describes both cases. The BI server provides the report to the user of the repository explorer 504. The user reviews the report with the appropriate tool, such as, a report viewer or report designer defined by instructions in the BI module 116. The user selects a report part. Executable instructions in the widget creator module 122 accept the selection of a report part from the report 506.

Executable instructions in BI module 116 separate the report part from the report 508. A report part is a section, table, chart, map, cell, control, and the like from a report. The report part may depend on other elements in a report or the context of the report. For example, if the selected report part includes a calculated value, that value will have dependent elements. The dependent elements include other report parts, formulas, parameters, data source information, and the like. Context of the report may include which user is looking at the report, the roll of the user, the report part Identification number (ID), the system name, the system Universal Resource Locator (URL), localization settings and the like. The dependent elements that are needed to support the selected report part are found 510.

The selected report part and all dependent elements are encapsulated in a widget 512. The widget creator module 122 builds a widget that includes the selected report part. The connection information of the data source for the report is stored in the widget. Connection information includes names, location, authentication information, version, protocol, and the like. The current data for the report is stored in the widget, the dependent elements are stored in the widget. In an embodiment, controls like drop down lists or text boxes for parameters are included and displayed in the widget. In an embodiment, the controls are disabled.

In the final operation of FIG. 5, credentials are inserted into the widget instance 514. The operation is the same as operation 406 of FIG. 4. The credentials are inserted to personalize the function of the widget. In an embodiment, after operation 514 the user is prompted to set up any further configuration information. In another embodiment, the widget is transferred to its new environment.

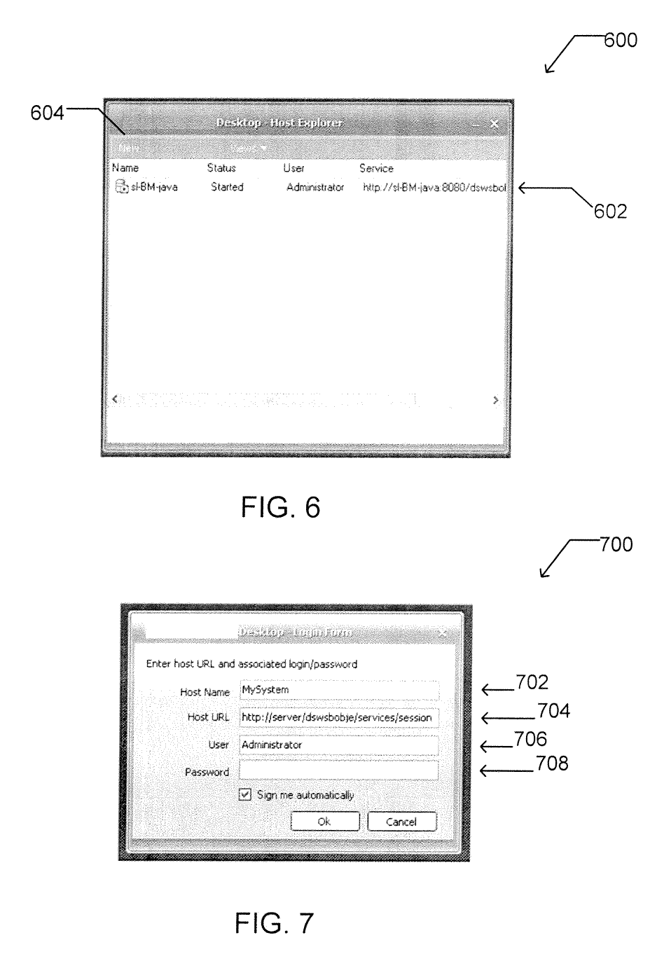

In an embodiment, alerts are used to distribute widgets. An alert can be serviced by sending a widget to a user. The widget sent as part of the alert service can be a widget instance or widget template. The user creates a personalized widget instance from the alert. The user specifies this information (e.g., credentials and configuration information) with operations 406 in FIG. 4 and 514 in FIG. 5. The specification is via user interface gestures such as drag-and-drop, wizards, prompts for additional information, and the like. As in the case of FIGS. 4 and 5, this is a workflow where the user specifies the information without programming. FIG. 6 illustrates a graphical user interface (GUI) including a repository explorer 600 in accordance with an embodiment of the invention. The explorer shows the name, status, and other information 602 about the repositories the explorer 600 is connected to. As illustrated by the information on line 602, the repository explorer 600 is connected to one repository. The user can add a repository by selecting the new button 604.

FIG. 7 illustrates a dialog box 700. The dialog box 700 is part of a workflow for adding another repository connection to the repository explorer of FIG. 6. The dialog box 700 is presented to the user. The user enters the name 702, location 704, user 706 and password 708 for the repository they intend to connect to.

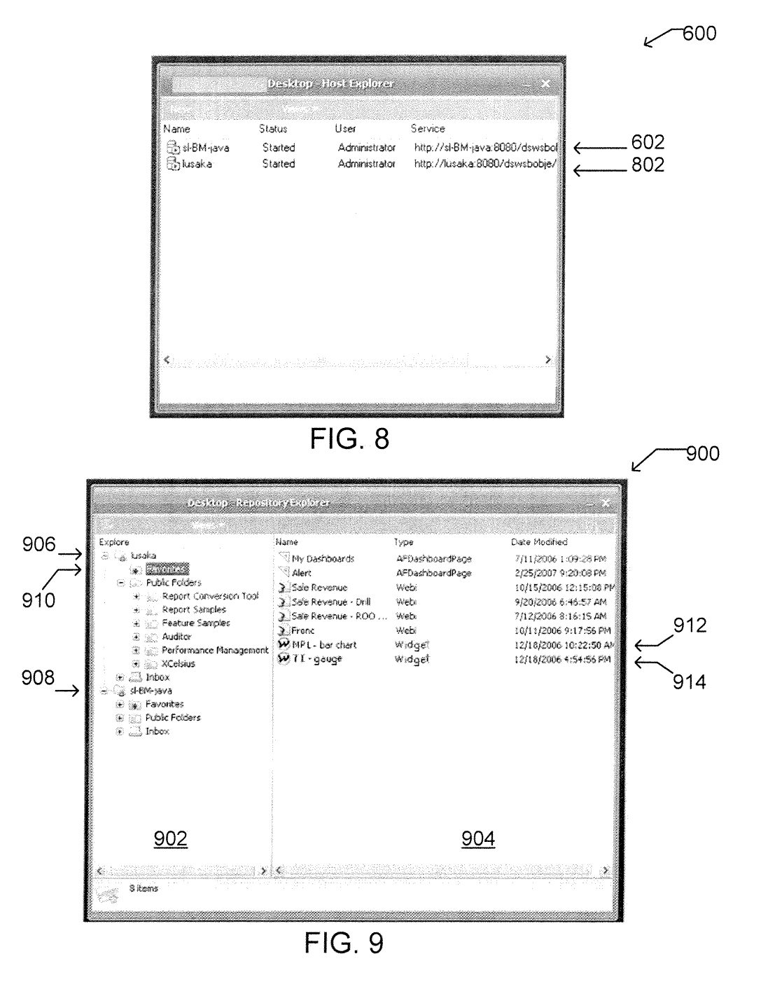

FIG. 8 illustrates the repository explorer 600 connected to two repositories. This is shown by the information on line 602 and line 802. The user can explore the items in each repository.

FIG. 9 illustrates the repository explorer showing a detailed view 900 of items in the two connected repositories. The repository explorer 900 helps the user navigate through the items in the repositories. The explorer includes a folder pane 902, which includes a hierarchy of the items the repository explorer can view. The view of the explorer is based on what the user may access in the repository. As illustrated in FIG. 9, the folder pane 902 shows two joined hierarchies for two repositories. The hierarchy can be changed as a matter of user preference. Also included in the explorer 900 is a list pane 904. The list pane displays the items in a folder selected from the folder pane 902.

The folder pane 902 includes folders from two repositories. A first repository is shown with a partially expanded folder hierarchy 906. The items in a second repository are in the collapsed hierarchy 908. The first repository includes a Favorites folder 910. As shown in FIG. 9, the Favorites folder is selected.

The list pane 904 shows a plurality of items in the Favorites folder 910. The items include a first widget 912 and a second widget 914. The first widget 912 is a bar chart. The second widget 914 is a gauge chart. The user can select these widgets and drag them to the desktop or another suitable new environment.

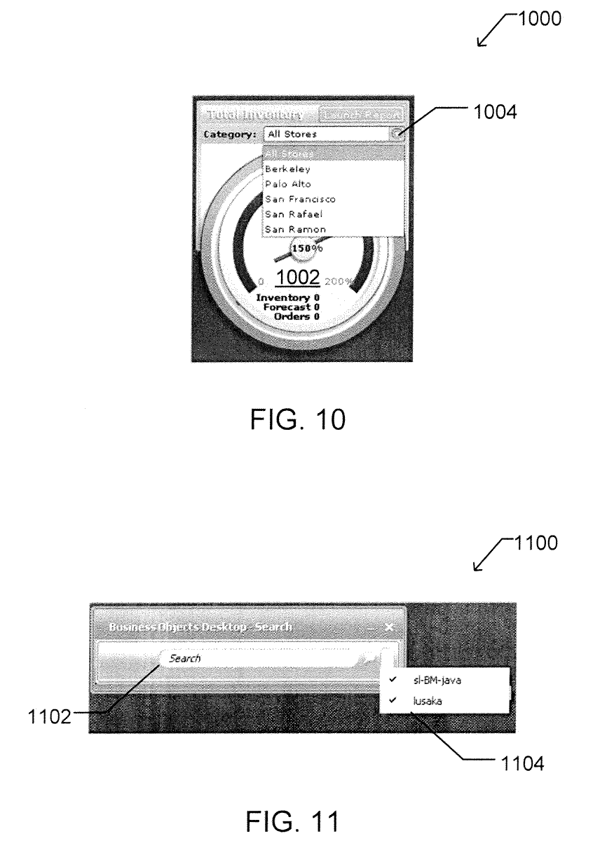

FIGS. 10, 11 and 12 illustrate a series of widgets placed on the desktop of the GUI of an operating system in accordance with an embodiment of the invention. In FIG. 10, the widget 914 of FIG. 9 has been dragged from the explorer 900 to create a widget 1000 on an operating system desktop. In this drag-and-drop action the widget is configured according to the processing operations described in FIG. 4. The widget includes a gauge chart 1002 plotting information subject to a drop down list control 1004.

FIG. 11 shows a search widget 1100 that can be used to locate documents in a repository. The search widget 1100 is configured to be a mini-repository explorer. It includes a text box 1102 for search terms and an options control 1104 for controlling the search location. The search widget is suitable for a thin client architecture where the repository explorer resides on a server.

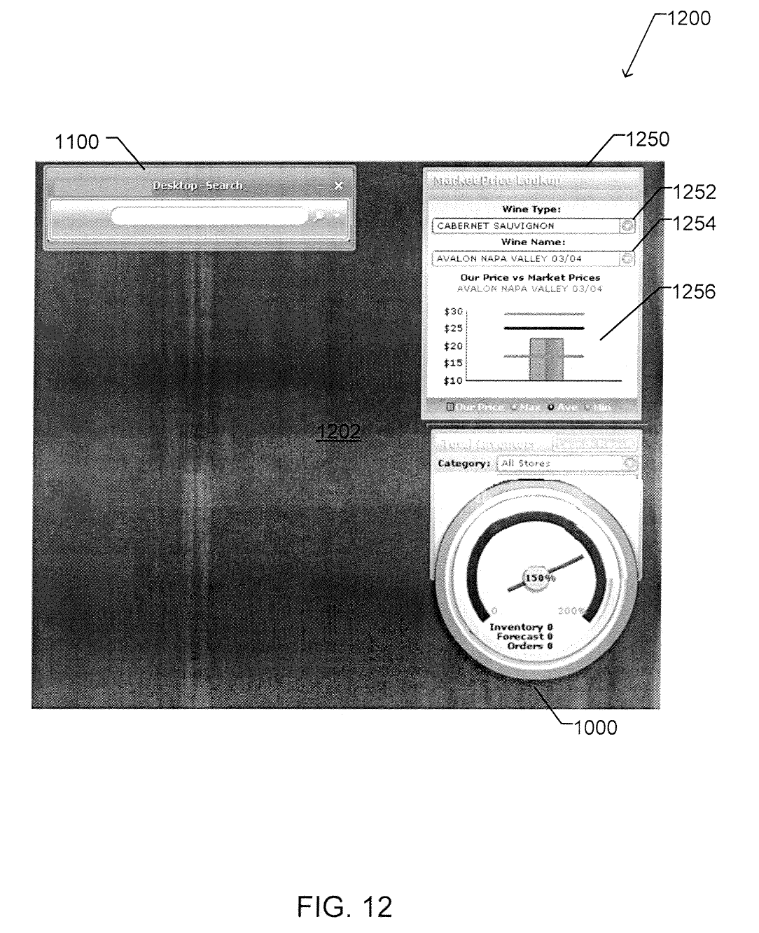

FIG. 12 illustrates a GUI 1200 with a series of widgets placed on the desktop 1202 of an operating system. Included in the GUI 1200 are the gauge chart widget 1000, the search widget 1100 and a bar chart widget 1250. The bar chart widget includes two controls 1252 and 1254. The controls are used to parameterize the formulas applied to the data plotted in the bar chart 1256.

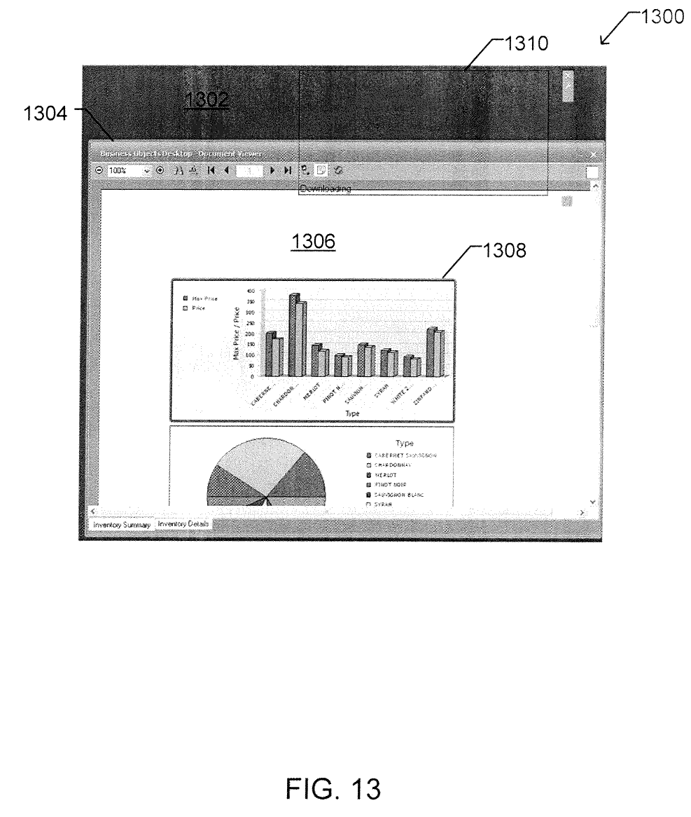

FIG. 13 illustrates the creation of a widget from a report part in accordance with an embodiment of the invention. The widget will be created on the desktop 1302. A reporting tool 1304 is running on the desktop 1302. The report tooling includes the report 1306 which has one or more report parts. The report parts include chart 1308. The user selects the report part and drags it to the desktop 1302. Executable instructions in the widget creator module 122 transform the report part 1306 into a widget according to the operations described in FIG. 5. The widget is created in the placeholder 1310.

Herein, when introducing elements of embodiments of the invention the articles “a”, “an”, “the” and “said” are intended to mean that there are one or more of the elements. The terms “comprising”, “including” and “having” are intended to be inclusive and to mean that there may be additional elements other than the listed elements.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
retrieve a list of one or more widgets from a repository;
display a set of items representing the list of one or more widgets from the repository:
accept a selection of a widget from amongst the one or more widgets in the repository; and
configure the widget with a set of authentication credentials.

2. The computer readable storage medium of claim 1 further comprising executable instructions to define a widget.

3. The computer readable storage medium of claim 2 further comprising executable instructions to include a set of data connection information in the widget.

4. The computer readable storage medium of claim 3 wherein the widget is a consumer of a web service.

5. The computer readable storage medium of claim 1 further comprising executable instructions to accept a selection of a report part from a report within the repository and create a widget template from the report part.

6. The computer readable storage medium of claim 1 further comprising executable instructions to:
prompt a user for a set of configuration data; and
configure the widget to include the set of configuration data.

7. The computer readable storage medium of claim 1 wherein the set of authentication credentials includes a set of user authentication credentials.

8. The computer readable storage medium of claim 1 wherein:
the repository includes two or more business intelligence documents; and
one of the two or more business intelligence documents is of a type selected from widgets and reports.

9. The computer readable storage medium of claim 1 further comprising executable instructions to transfer the widget to a new environment.

10. The computer readable storage medium of claim 1 wherein the repository is located at a server.

11. A computer readable storage medium, comprising executable instructions to:
define a repository at a business intelligence server, wherein the repository stores business intelligence documents;
interface a repository explorer with the repository, wherein the repository explorer accesses a set of business intelligence documents in the repository; and
create a widget instance, wherein:
the widget instance is based on a business intelligence document from the set of business intelligence documents in the repository and a set of information that personalizes the operation of the widget.

12. The computer readable storage medium of claim 11 wherein the set of information includes authentication credentials.

13. The computer readable storage medium of claim 11 wherein the set of information includes data connection information.

14. The computer readable storage medium of claim 13 further comprising executable instructions to provide a web service to supply the widget instance with data from a data source.

15. The computer readable storage medium of claim 11 further comprising executable instructions to make the widget instance from a report.

16. The computer readable storage medium of claim 11 wherein the set of information is information of one or more types selected from saved data and configuration information.

17. The computer readable storage medium of claim 11 wherein the repository explorer is located at a business intelligence client.

18. The computer readable storage medium of claim 11 further comprising one or more executable instructions selected from:
executable instructions to transfer a widget instance to a client, and
executable instructions to save the widget instance in the repository.

19. The computer readable storage medium of claim 11 further comprising one or more executable instructions selected from:
executable instructions to create the widget instance from a widget template,
executable instructions to create the widget instance from a report part, and
executable instructions to create the widget instance from another widget instance.

20. The computer readable storage medium of claim 19 wherein the executable instructions to create the widget instance from a report part include executable instructions to include information describing the context of the report part in the widget instance.

21. The computer readable storage medium of claim 19 wherein the executable instructions to create the widget instance from a report part include executable instructions to include the a set of dependent elements for the report part, wherein the set of dependent elements is two or more elements selected from another report part, a formula, a parameter, and a set of data source connection information.
